(19) United States
(12) Patent Application Publication
(10) Pub. No.: US 2025/0296180 A1
(43) Pub. Date: Sep. 25, 2025

(54) WELDING FIXTURE FOR BOX-TYPE PARTS, INTELLIGENT PRODUCTION LINE, AND METHOD FOR WELDING BOX-TYPE PARTS

(71) Applicant: QINGDAO UNIVERSITY OF TECHNOLOGY, Qingdao (CN)

(72) Inventors: Xin CUI, Qingdao (CN); Liuyang LI, Qingdao (CN); Yanbin ZHANG, Qingdao (CN); Juxin HUANG, Qingdao (CN); Huating LI, Qingdao (CN); Chong WANG, Qingdao (CN); Xiaoliang LIANG, Qingdao (CN); Chunjin WANG, Qingdao (CN); Changhe LI, Qingdao (CN)

(21) Appl. No.: 18/743,330

(22) Filed: Jun. 14, 2024

(30) Foreign Application Priority Data
Mar. 20, 2024 (CN) 2024103219866

(51) Int. Cl. B23K 37/04; B23K 37/02; B23K 37/047

(52) U.S. Cl. CPC B23K 37/0443; B23K 37/0211; B23K 37/047

(57) ABSTRACT

The present invention belongs to the technical field of intelligent welding, provides a welding fixture for box-type parts, an intelligent production line, and a welding method. The welding fixture comprises a two-dimensional moving apparatus, and a plurality of lifting apparatuses arranged on the two-dimensional moving apparatus, each lifting apparatus includes a first electromagnet arranged at the first end far away from the two-dimensional moving apparatus, and a second electromagnet arranged at a second end close to the two-dimensional moving apparatus, the first electromagnet is provided with three mutually perpendicular magnetic surfaces, and the second electromagnet is provided with two mutually perpendicular magnetic surfaces, which realizes a three-dimensional moving adjustment by arranging a plurality of lifting apparatuses on a two-dimensional moving apparatus, the box-type parts with different specifications can be accurately positioned and held through the cooperation of the plurality of the first electromagnets and the plurality of the second electromagnets.

### TECHNICAL FIELD

The invention belongs to the technical field of intelligent welding, and it particularly relates to a welding fixture for box-type parts, an intelligent production line, and a method for welding box-type parts.

### BACKGROUND ART

Intelligent welding is mainly used in manufacturing, construction, and automobile industries, etc., but is less used in the field of commercial kitchenware. Box-type parts are often welded manually, and there will be problems such as poor consistency, low welding efficiency, and welding quality depending on the manual technology level in the welding process. Therefore, it is of great significance to realize intelligent welding of box-type parts for enterprises to improve production efficiency.

The inventor finds that in the intelligent welding production line of the box-type parts, at present, cylinders are generally used to position the box-type parts in the welding fixture, the positioning accuracy thereof is low, which affects the width of the welding seam during the welding, and the welding quality; moreover, because the shapes of the box-type parts are different in actual production, the traditional welding fixture cannot effectively hold and position the box-type parts with different specifications.

### SUMMARY OF THE INVENTION

To solve the above problems, the present invention provides a welding fixture for box-type parts, an intelligent production line, and a method for welding the box-type parts, wherein the box-type parts with different specifications can be accurately positioned and held through the cooperation of a plurality of first electromagnets and a plurality of second electromagnets on a basis of an arrangement of a two-dimensional moving apparatus and lifting apparatuses.

In order to achieve the above object, in a first aspect, the present invention provides a welding fixture for box-type parts, adopting the following technical solution.

The welding fixture for box-type parts, including a two-dimensional moving apparatus, and a plurality of lifting apparatuses arranged on the two-dimensional moving apparatus; wherein,
each of the plurality of lifting apparatuses includes a first electromagnet being arranged at a first end of the lifting apparatus far away from the two-dimensional moving apparatus, and a second electromagnet being arranged at a second end of the lifting apparatus close to the two-dimensional moving apparatus; wherein, the first electromagnet is provided with three mutually perpendicular magnetic surfaces, and the second electromagnet is provided with two mutually perpendicular magnetic surfaces.

Further, the two-dimensional moving apparatus includes a first guide rail and a second guide rail that can move perpendicular to each other on a horizontal plane (i.e. X-Y plane).

Further, the first electromagnet includes a first shell, internal spaces of the first shell corresponding to the three mutually perpendicular magnetic surfaces of the first electromagnet are respectively provided with a frame, and an enameled wire is wound around the frame; and, the second electromagnet includes a second shell, internal spaces of the second shell corresponding to the two mutually perpendicular magnetic surfaces of the second electromagnet are respectively provided with a frame and an enameled wire is wound around the frame.

In order to achieve the above object, in a second aspect, the present invention further provides an intelligent production line for welding the box-type parts, adopting the following technical solution.

An intelligent production line for welding the box-type parts, including a first conveyor belt, a welding fixture arranged on a first end of the first conveyor belt, a welding robot being arranged on a first side of the welding fixture, a sucker robot being arranged on a first side of the first conveyor belt and close to the welding fixture, and a second conveyor belt; wherein,
the welding fixture includes a two-dimensional moving apparatus, and a plurality of lifting apparatuses arranged on the two-dimensional moving apparatus; wherein,
each of the plurality of lifting apparatuses includes a first electromagnet being arranged at a first end of the lifting apparatus far away from the two-dimensional moving apparatus, and a second electromagnet being arranged at a second end of the lifting apparatus close to the two-dimensional moving apparatus; wherein, the first electromagnet is provided with three mutually perpendicular magnetic surfaces, and the second electromagnet is provided with two mutually perpendicular magnetic surfaces.

Further, a camera is arranged above the first conveyor belt to identify sheet metal dimensions of the box-type parts on the first conveyor belt; according to the identified sheet metal dimensions, an adjustment position of each of the plurality of lifting apparatuses by the two-dimensional moving apparatus and an adjustment height of the each of the plurality of lifting apparatuses can be determined.

Further, the sucker robot includes the first robotic arm and suction cups disposed on the end of the first robotic arm.

Further, the welding robot includes the second robotic arm, a welding gun, a camera, and an annular light source arranged on the second robotic arm.

In order to achieve the above object, in a third aspect, the present invention further provides a method for welding box-type parts, adopting the following technical solution.

A method for welding box-type parts, using the intelligent production line for welding the box-type parts according to the second aspect, including:
adjusting, by a two-dimensional moving apparatus a position of each of a plurality of lifting apparatuses, and determining a height of the each of the plurality of lifting apparatuses according to sheet metal dimensions of an object to be welded; after the adjustments of the two-dimensional moving apparatus and the plurality of lifting apparatuses, holding and positioning the object to be welded by using a first electromagnet and a second electromagnet on the each of the plurality of lifting apparatuses; and, after the object to be welded are positioned, welding, by a welding robot, the object to be welded in one piece.

Further, acquiring, by a camera on the welding robot, an image of surface shape of the object to be welded and an image of welding seam;
carrying out a gray-scale processing and a noise elimination processing on color images acquired by the camera; carrying out a gray-scale stretching on the processed image of the welding seam; segmenting the stretched image of the welding seam; and, eliminating an interference information of holes on the segmented image of the welding seam through an image morphology operation; and
screening points of which a gray value is greater than 0 in each row in the segmented image of the welding seam, then the screened points are of points of an area of the welding seam, and using the points to calculate a gray-scale center of gravity of each the row; and then, calculating, row by row, coordinates of a center of the gravity of the welding seam, as coordinates of a middle point.

Further, planning, by a linear interpolation algorithm, a welding path of a robotic arm of the welding robot; performing, by a welding gun on the welding robot, the welding according to the planned straight line, wherein calculating the coordinates of middle points of the welding seam after determining a starting point and an ending point of the welding seam of the object to be welded, and simulating, by the robotic arm of the welding robot passing through each of the middle points, a linear motion track.

Compared with the prior art, the invention has the beneficial effects that:

The present invention realizes a three-dimensional moving adjustment by arranging a plurality of lifting apparatuses on a two-dimensional moving apparatus; each lifting apparatus includes a first electromagnet being arranged at the first end of the lifting apparatus far away from the two-dimensional moving apparatus, and a second electromagnet being arranged at a second end of the lifting apparatus close to the two-dimensional moving apparatus; wherein, the first electromagnet is provided with three mutually perpendicular magnetic surfaces, and the second electromagnet is provided with two mutually perpendicular magnetic surfaces. Based on the arrangement of the two-dimensional moving apparatus and the plurality of the lifting apparatuses, the box-type parts with different specifications can be accurately positioned and held through the cooperation of the plurality of the first electromagnets and the plurality of the second electromagnets.

### BRIEF DESCRIPTION OF DRAWINGS

The accompanying drawings constituting a part of the present invention are used to provide a further understanding of the present invention. The exemplary examples of the present invention and descriptions thereof are used to explain the present invention and do not constitute an improper limitation of the present invention.

FIG. 1 is an isometric view of an intelligent production line according to Example 1 of the present invention.

FIG. 2 is an isometric view of a welding fixture according to Example 1 of the present invention.

FIG. 3 is an exploded view of the welding fixture according to Example 1 of the present invention.

FIG. 4 is an isometric view of a two-dimensional moving apparatus and a plurality of lifting apparatuses according to Example 1 of the present invention.

FIG. 5 is an exploded view of the two-dimensional moving apparatus and the plurality of the lifting apparatuses according to Example 1 of the present invention.

FIG. 6 is an isometric view of one of the plurality of lifting apparatuses according to Example 1 of the present invention.

FIG. 7 is an exploded view of the lifting apparatus according to Example 1 of the present invention.

FIG. 8 is an isometric view of a worm screw lifting apparatus according to Example 1 of the present invention.

FIG. 9 is an exploded view of the two-dimensional moving apparatus according to Example 1 of the present invention.

FIG. 10 is an exploded view of the first electromagnet according to Example 1 of the present invention.

FIG. 11 is a sectional view of the first electromagnet according to Example 1 of the present invention.

FIG. 12 is an exploded view of the second electromagnet according to Example 1 of the present invention.

FIG. 13 is a sectional view of the second electromagnet according to Example 1 of the present invention.

FIG. 14 is an isometric view of a sucker robot according to Example 1 of the present invention.

FIG. 15 is an isometric view of suction cups according to Example 1 of the present invention.

FIG. 16 is an isometric view of a welding robot according to Example 1 of the present invention.

FIG. 17 is an isometric view of a weld-seam visual recognition device according to Example 1 of the present invention.

FIG. 18 is a flow chart of weld-seam visual recognition according to Example 1 of the present invention.

FIG. 19 is an isometric view of the first conveyor belt according to Example 1 of the present invention.

FIG. 20 is an isometric view of a visual recognition device for sheet metal dimensions of box-type parts according to Example 1 of the present invention.

FIG. 21 is a process flow diagram of an intelligent production line according to Example 1 of the present invention.

Wherein, in the figures, 1—fixture, 101—lifting apparatus, 10101—first electromagnet, 1010101—first resin cover, 1010102—first enameled wire, 1010103—first frame, 1010104—first shell, 1010105—first magnetic surface, 1010106—second frame, 1010107—second enameled wire, 1010108—second resin cover, 1010109—third resin cover, 1010110—third enameled wire, 1010111—third frame, 1010112—third magnetic surface, 1010113—power cord, 1010114—threaded hole, 10102—worm screw lifting apparatus, 1010201—flange plate, 1010202—first screw rod, 1010203—first hexagon socket head screw, 1010204—shaft, 1010205—through hole, 1010206—second hexagon socket head screw, 10103—lifting apparatus fixing screws, 10104—lifting apparatus fixing plate, 10105—first cylindrical pin, 10106 first stepping motor, 10107—stepping motor first fixing screw, 10108—stepping motor bracket, 10109—stepping motor second fixing screw, 10110—first coupling, 10111—first base, 10112—second electromagnet, 1011201—second shell, 1011202—fourth frame, 1011203—fourth enameled wire, 1011204—fourth resin cover, 1011205—fifth enameled wire, 1011206—fifth frame, 1011207—fifth resin cover, 1011208—fourth magnetic surface, 1011209—fifth magnetic surface, 10113—electromagnet fixing screw, 10114—first diamond pin, 10115—electromagnet fixing plate, 10116—first fixing block, 10117—second cylindrical pin, 10118—first fixing screw, 10119—base fixing screw, 10120—second electromagnet base, 10121—second fixing screw, 10122—first nut, 10123—second diamond pin, 10124—third fixing screw, 10125—third cylindrical pin, 10126—second base, 10127—fourth fixing screw, 10128—L-shaped sheet metal, 10129—third hexagon socket head screw, 10130—fourth cylindrical pin, 10131—fifth fixing screw, 102—two-dimensional moving apparatus, 10201—second stepping motor, 10202—second coupling, 10203—first fixing plate, 10204—sealing ring, 10205—cover plate, 10206—first bearing, 10207—second fixing plate, 10208—second fixing block, 10209—slide rail, 102010—second screw rod, 102011—slider, 102012—second nut, 102013—third fixing block, 102014—bearing bracket, 102015—second bearing, 103—first guard board, 104—floating plate, 105—guard board fixing plate, 106—sixth fixing screw, 107—guard board fixing support, 108—seventh fixing screw, 109—second guard board, 110—fixture base, 111—guard board fixing support fixing screw, 112—eighth fixing screw, 113—X/Y-direction connecting plate, 114—first guide rail, 115—ninth fixing screw, 116—second guide rail, 117—third base, 118—tenth fixing screw, 119—fourth base, 120—third nut, 121—moving block, 122—third stepping motor, 2—welding robot, 201—welding gun, 202—vision recognition device, 20201—first annular light source, 20202—lens, 20203—second CCD camera, 20201—fourth fixed block, 203—first robotic arm, 3—second conveyor belt, 4—sucker robot, 401—second robotic arm, 402—suction-cup assembly, 40201—air pipe, 40202—suction cups, 40203—aluminum profile frame, 40204—first sheet metal, 40205—fourth nut, 40206—second sheet metal, 40207—sixth frame, 40208—eleventh fixing screw, 40209—twelfth fixing screw, 402010—fifth nut, 402011—sixth nut, 402012—butterfly nut, 402013—third sheet metal, 402014—fixing nut, 5—first conveyor belt, 501—first CCD camera, 502—annular light source frame, 503—cross-bar, 504—clamping block, 505—fastening screw, 506—fourth sheet metal, 507—fifth sheet metal, 508—first conveyor belt support, 509—second annular light source, 510—vertical rod, 511—first CCD camera bracket, 512—cross rod clamping block, 513—vertical rod base, 6—protective grille.

### DETAILED DESCRIPTION

The present invention will now be further described with reference to the accompanying drawings and examples.

It should be pointed out that the following detailed descriptions are all illustrative and are intended to provide further descriptions of the present invention. Unless otherwise specified, all technical and scientific terms used in the present invention have the same meanings as those usually understood by a person of ordinary skill in the art to which the present invention belongs.

### Example 1

At present, in the intelligent welding production line of box-type parts, the cylinders are generally used for positioning box-type parts in the welding fixture, of which the positioning accuracy is low, affecting the welding seam width during the welding and the welding quality; moreover, because the shapes of the box-type parts are different in actual production, the traditional welding fixture cannot effectively hold and position the box-type parts with different specifications.

In view of the above problems, the present example provides a welding fixture for box-type parts, including a two-dimensional moving apparatus 102 and a plurality of lifting apparatuses 101 disposed on the two-dimensional moving apparatus 102.

Wherein, each of the plurality of the lifting apparatuses 101 includes a first electromagnet arranged at a first end of the lifting apparatus far away from the two-dimensional moving apparatus 102, and a second electromagnet arranged at a second end of the lifting apparatus close to the two-dimensional moving apparatus102; wherein, the first electromagnet is provided with three mutually perpendicular magnetic surfaces, and the second electromagnet is provided with two mutually perpendicular magnetic surfaces.

Optionally, the two-dimensional moving apparatus includes a first guide rail and a second guide rail that can move perpendicular to each other on a horizontal plane. The first electromagnet includes a first shell, internal spaces of the first shell corresponding to the three mutually perpendicular magnetic surfaces of the first electromagnet are respectively provided with a frame, and an enameled wire is wound around the frame; the second electromagnet includes a second shell, internal spaces of the second shell corresponding to the two mutually perpendicular magnetic surfaces of the second electromagnet are respectively provided with a frame, and an enameled wire is wound around the frame.

Specifically, by the arrangement of the two-dimensional moving apparatus 102 and the plurality of the lifting apparatuses 101 disposed thereon, the purpose of a three-dimensional moving adjustment is realized; each the lifting apparatus 101 includes the first electromagnet being arranged at the first end thereof far away from the two-dimensional moving apparatus 102, and the second electromagnet being arranged at the second end thereof close to the two-dimensional moving apparatus 102; wherein, the first electromagnet is provided with three mutually perpendicular magnetic surfaces, and the second electromagnet is provided with two mutually perpendicular magnetic surfaces. Based on the arrangement of the two-dimensional moving apparatus and the plurality of the lifting apparatuses, the box-type part bodies with different specifications can be accurately positioned and held through the cooperation of the first electromagnets and the second electromagnets on the plurality of the lifting apparatuses 101.

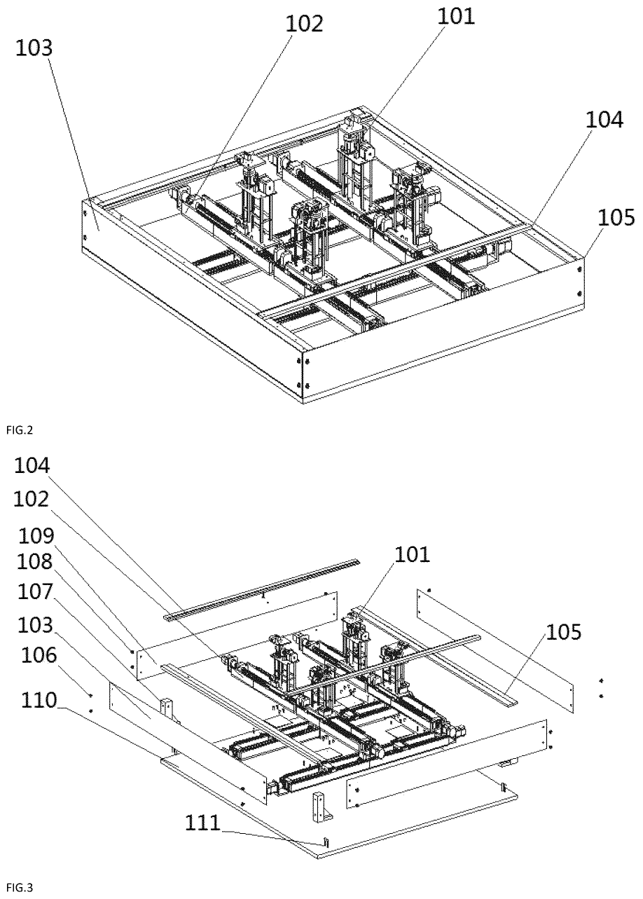

As shown in FIGS. 2 and 3, the welding fixture 1 includes the plurality of the lifting apparatuses 101, and the two-dimensional moving apparatus 102, and further includes two first guard boards 103 and two second guard boards 109 being connected end by end in sequence by fixing ends of the two first guard boards 103 and two second guard boards on four guard board fixing supports 107, respectively, wherein the ends of the two first guard boards 103 are fixed on the four guard board fixing supports 107 through sixth fixing screws 106, and the ends of the two second guard boards 109 are fixed on the four guard board fixing supports 107 through seventh fixing screws 108; both ends of two guard board fixing plates 105 arranged parallel to the two first guard boards 103 are fixed on the four guard board fixing supports 107 through screws, two floating plates 104 are fixed on the two guard board fixing plates 105 through cylindrical pins, and the four guard board fixing supports 107 are fixing on a fixture base 110 through guard board fixing support fixing screws 111.

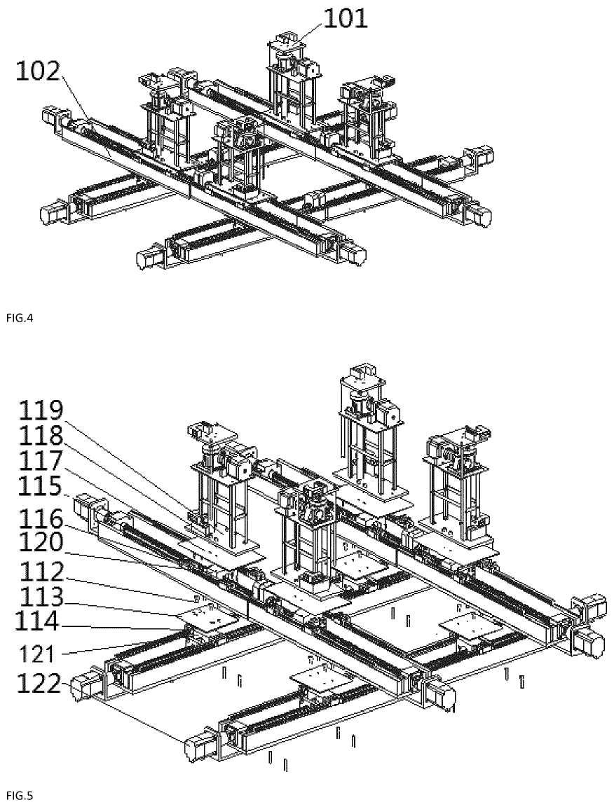

As shown in FIGS. 4 and 5, a combination of the plurality of the lifting apparatuses 101 and the two-dimensional moving apparatus 102 of the fixture 1 of the present example forms a three-dimensional moving structure that can provide movements on the x, y, and z axes. As shown in FIG. 5, the two-dimensional moving apparatus 102 includes two parallel first guide rails 114 and two parallel second guide rails being connected to each other through X/Y-direction connecting plates 113, third bases 117, tenth fixing screws 118, fourth bases 119, moving blocks 121, and third stepping motors 122.

Wherein, the X/Y-direction connecting plates 113 and the third base 117 are provided with through holes, the third base 117 and the fourth bases 119 are fixed together by the tenth fixing screws 118, and the third base 117 is fastened on the second guide rail 116 by the ninth fixing screw 115.

A Y-direction movement is realized by a stepping motor driving a screw rod of the second guide rails, and the second guide rails connected with the X/Y-direction connecting plates 113 through eighth fixing screws 112, the connection mode of the first guide rails and the second guide rails is the same as that of the second guide rails and the lifting apparatuses, the eighth fixing screws 112 connect the second guide rails and the X/Y-direction connecting plates 113 to the movement blocks 121 of the first guide rails 114.

The third stepping motor 122 drives the screw rod nut of the first guide rail to realize the X-direction movement of the apparatus, the sheet metal size of the box-type part is analyzed through a visual recognition device by using a calibration measurement system, to accurately detect the difference between the pixel size and the actual size in the image; the image is acquired by the first CCD camera 501, the image is subjected to preprocessing including image graying, histogram equalization and median filtering to improve the contrast of the image and reduce the noise of the sheet metal image, eliminating edge burrs of the images by using edge detection algorithm, and finally, deducing, by using the least square method, the real physical size of the sheet metal according to the difference between pixels of the image in the computer and actual values. The information is transmitted to the intelligent control system of the welding fixture. During positioning and holding, according to the sheet metal size of the box-type part identified by the first CCD camera 501, the first stepping motor 10106 rotates to drive the worm screw elevator 10102 to rise, and the first electromagnet 10101 moves to the height of the box-type part. According to the sheet metal size of the box-type part, the worm gear screw elevator 10102 is driven by the stepping motor to realize the X-direction movement to the length size of the box-type part; according to the sheet metal size of the box-type part, the worm gear screw elevator 10102 is driven by the stepping motor to realize the Y-direction movement to the width size of the box-type part; electromagnets and positioning blocks of floating plates position the sheet metal, and the electromagnets adsorb the sheet metal.

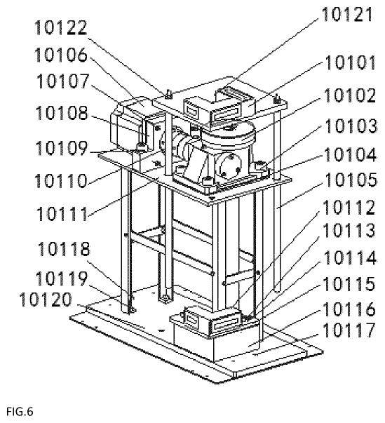

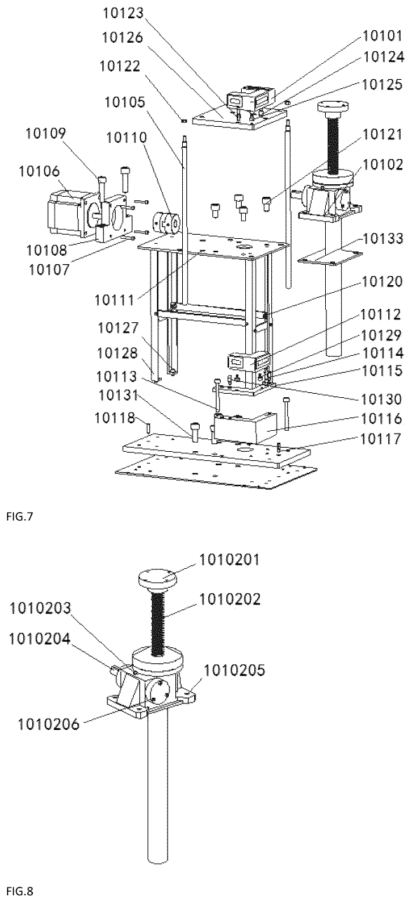

As shown in FIGS. 6 and 7, the first stepping motor 10106 is fixed by a stepping motor bracket 10108, the stepping motor first fixing screw 10107, and the stepping motor second fixing screw 10109. The first stepping motor 10106 drives the shaft of the worm screw elevator 10102 to rotate through a first coupling 10110, and the worm drives the worm wheel to decelerate. The central hole of the worm wheel is processed into trapezoidal internal threads to form a screw pair with the first screw rod 1010202, the first screw rod 1010202 completes lifting movement along with the rotation of the worm wheel, and the first screw rod 1010202 drives the flange plate 1010201 to lift, further, the flange plate 1010201 and the second base 10126 are fixed by screws, and the second base 10126 is positioned by two first cylindrical pins 10105. One end of the first cylindrical pin 10105 has external threads and is fixed on the second base 10126 through the first nut 10122, and the other end passes through the through hole to realize the positioning of the second base 10126. The L-shaped metal plates 10128 are fixedly connected through threads.

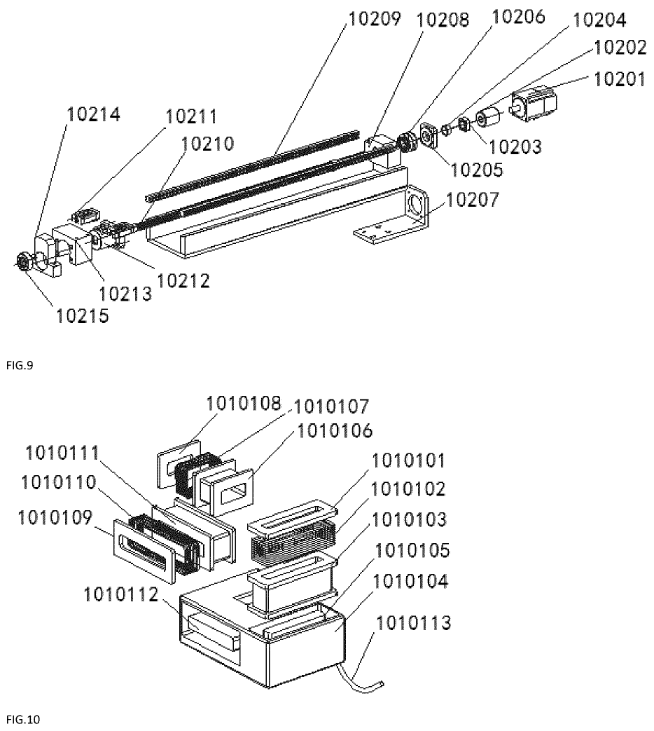

As shown in FIG. 9, the moving block or base is in threaded engagement with the slider 102011, and the second stepping motor 10201 drives the second screw rod 102010 to move the moving block or base on the slide rail 10209.

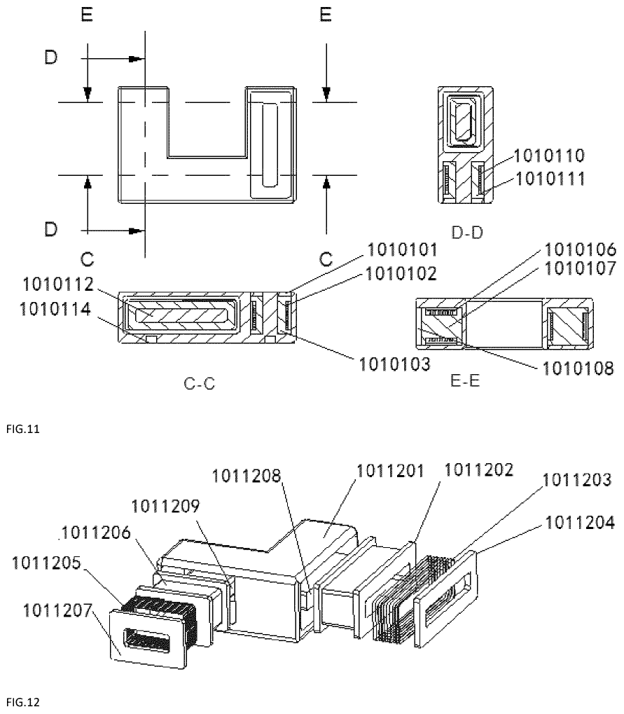

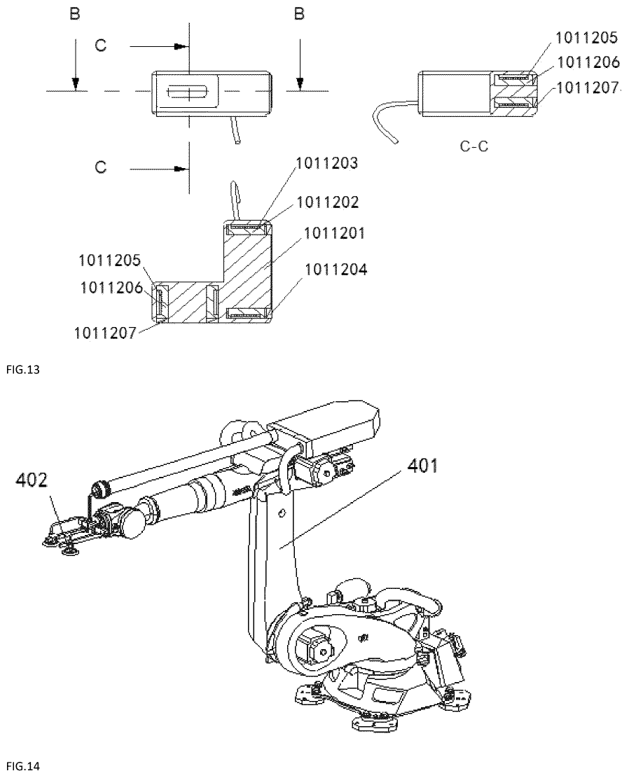

As shown in FIGS. 10-13, the first electromagnet 10101 and the second electromagnet 10112 positions the metal plate of the box-type part. The structure of the first electromagnet 10101 mainly includes, such as a first resin 1010101, a first enameled wire 1010102, a first framework 10103, and a first shell 1010104. The second electromagnet 10112 mainly includes, such as a second housing 101201, a fourth frame 101202, a fourth enameled wire 101203, and a fourth resin 101204.

The first electromagnet 10101 is a three-sided adsorption electromagnet to realize the adsorption of three sheet metals and is positioned on the second base 10126 through the second diamond pin 10123 and the third cylindrical pin 10125. The first electromagnet 10101 is connected with the second base 10126 through threads. The second electromagnet 10112 realizes the adsorption of two sheet metals, the second electromagnet 10112 and the electromagnet fixing plate 10115 are connected through threads, and the electromagnet fixing plate 10115 is positioned on the first fixing block 10116 through the fourth cylindrical pin 10130 and the first diamond pin 10114. The first fixing block 10116 is provided with a through-hole, and the electromagnet fixing screw 10113 is connected with the electromagnet fixing plate 10115, the first fixing block 10116, and the second electromagnet base 10120. When the electromagnet is energized, current is generated in the coil, and the electromagnet generates magnetic force to act on the sheet metal. In order to avoid the mutual influence of different magnetic force surfaces in the process of adsorbing the sheet metal by the electromagnet, The first shell 1010104, and the second shell 101201 are made of low carbon steel shell surface sprayed with Ni—Cu—Ni coating, and the third frame 1010111, the second frame 1010106, the first frame 1010103, the fifth frame 101206 and the fourth frame 101202 are made of polyethylene plastic.

### Example 2

The present example provides an intelligent production line for welding the box-type parts, including a first conveyor belt, a welding fixture 1 being arranged on the first end of the first conveyor belt, a welding robot 2 being arranged on the first side of the welding fixture, a sucker robot 4 arranged on a first side of the first conveyor belt and close to the welding fixture, and a second conveyor belt 3; all the features of the welding fixture in the present example are same as that of Example 1, and will not be described in detail herein.

The welding fixture 1 includes a two-dimensional moving apparatus 102 and a plurality of lifting apparatuses 101 disposed on the two-dimensional moving apparatus 102.

Each of the plurality of lifting apparatuses 101 includes a first electromagnet being arranged at the first end of the lifting apparatus far away from the two-dimensional moving apparatus 102, and a second electromagnet being arranged at a second end of the lifting apparatus close to the two-dimensional moving apparatus 102; wherein, the first electromagnet is provided with three mutually perpendicular magnetic surfaces, and the second electromagnet is provided with two mutually perpendicular magnetic surfaces.

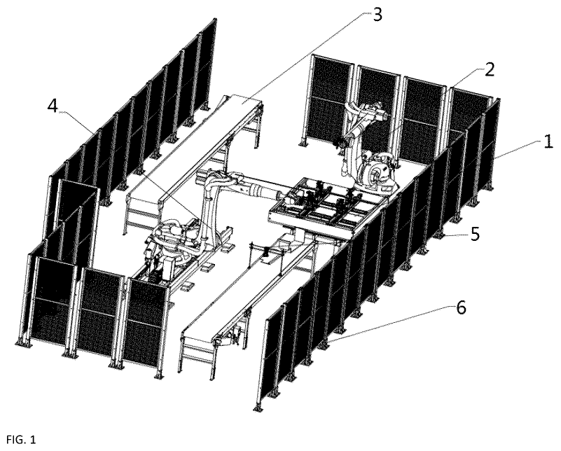

Specifically, as shown in FIG. 1, the intelligent production line for box-type parts provided in the present example includes a welding fixture 1, a welding robot 2, a second conveyor belt 3, a sucker robot 4, a vision recognition device 5, and a protective grid 6; wherein the second conveyor belt 3 is an output conveyor belt, the welding fixture 1 is fixed on a preset welding platform, the sucker robot 4 is fixed on a preset moving mechanism through bolts, to grab sheet metal and move the sheet metal to a welding area, and the vision recognition device 5 is fixed on a first conveyor belt being as an input conveyor belt through hexagon socket head screws, to recognize sheet metal with different shapes, including a CCD camera being connected with industrial computer through gigabit Ethernet port to collect images and transmit data. The welding robot 2 is fixed on the first side of the welding fixture 1 by bolts, another CCD camera provided at the front end of the welding gun identifies and detects the welding seam, and the control system transmits signals to the robot arm of the welding robot to drive the welding gun to weld the welding seam, the robot control cabinet is connected with the industrial control computer in a gigabit Ethernet mode for transmitting the position information of the welding seam, the robot arm control cabinet is connected with the welding machine through a communication bus, The welding robot 2 is a 6-axis robot for controlling parameters such as welding current, voltage, and the like in real-time, and for welding seams of the box-type parts with different shapes. The intelligent welding production line is separated from the outside by the protective grid 6, which is an enclosure or the like.

As shown in FIGS. 2 and 3, the welding fixture 1 includes the lifting apparatuses 101, and the two-dimensional moving apparatus 102, and further includes first guard boards 103 and second guard boards 109 being connected end by end in sequence by fixing ends of the first guard boards 103 and second guard boards on four guard board fixing supports 107, respectively, wherein the ends of the two first guard boards 103 are fixed on the four guard board fixing supports 107 through sixth fixing screws 106, and the ends of the two second guard boards 109 are fixed on the four guard board fixing supports 107 through seventh fixing screws 108; both ends of two guard board fixing plates 105 arranged parallel to the two first guard boards 103 are fixed on the four guard board fixing supports 107 through screws, two floating plates 104 are fixed on the two guard board fixing plates 105 through cylindrical pins, and the four guard board fixing supports 107 are fixing on a fixture base 110 through guard board fixing support fixing screws 111.

As shown in FIGS. 4 and 5, a combination of the plurality of the lifting apparatuses 101 and the two-dimensional moving apparatus 102 of the fixture 1 of the present example forms a three-dimensional moving structure that can provide movements on the x, y, and z axes. As shown in FIG. 5, the two-dimensional moving apparatus 102 includes, such as, two parallel first guide rails 114 and two parallel second guide rails being connected through X/Y-direction connecting plates 113, third bases 117, fourth bases 119, moving blocks 121, and third stepping motors 122.

Wherein, the X/Y-direction connecting plates 113 and the third base 117 are provided with through holes, the third base 117 and the fourth bases 119 are fixed together by the tenth fixing screws 118, and the third base 117 is fastened on the second guide rail 116 by the ninth fixing screw 115.

The first electromagnet 10101 is a three-sided adsorption electromagnet to realize the adsorption of three sheet metals and is positioned on the second base 10126 through the second diamond pin 10123 and the third cylindrical pin 10125. The first electromagnet 10101 is connected with the second base 10126 through threads. The second electromagnet 10112 realizes the adsorption of two sheet metals, the second electromagnet 10112 and the electromagnet fixing plate 10115 are connected through threads, and the electromagnet fixing plate 10115 is positioned on the first fixing block 10116 through the fourth cylindrical pin 10130 and the first diamond pin 10114. The first fixing block 10116 is provided with a through-hole, and the electromagnet fixing screw 10113 is connected with the electromagnet fixing plate 10115, the first fixing block 10116, and the second electromagnet base 10120. When the electromagnet is energized, current is generated in the coil, and the electromagnet generates magnetic force to act on the sheet metal. In order to avoid the mutual influence of different magnetic force surfaces in the process of adsorbing the sheet metal by the electromagnet, The first shell 1010104, and the second shell 101201 are made of low carbon steel shell surface sprayed with Ni—Cu—Ni coating, and the third frame 1010111, the second frame 1010106, the first frame 1010103, the fifth frame 101206 and the fourth frame 101202 are made of polyethylene plastic.

As shown in FIGS. 6 and 7, the first stepping motor 10106 is fixed by a stepping motor bracket 10108, the stepping motor first fixing screw 10107, and the stepping motor second fixing screw 10109. The first stepping motor 10106 drives the shaft of the worm screw elevator 10102 to rotate through a first coupling 10110, and the worm drives the worm wheel to decelerate. The central hole of the worm wheel is processed into trapezoidal internal threads to form a screw pair with the first screw rod 1010202, the first screw rod 1010202 completes lifting movement along with the rotation of the worm wheel, and the first screw rod 1010202 drives the flange plate 1010201 to lift, further, the flange plate 1010201 and the second base 10126 are fixed by screws, and the second base 10126 is positioned by two first cylindrical pins 10105. One end of the first cylindrical pin 10105 has external threads and is fixed on the second base 10126 through the first nut 10122, and the other end passes through the through hole to realize the positioning of the second base 10126. The L-shaped metal plates 10128 are fixedly connected through threads.

As shown in FIG. 9, the moving block or base is in threaded engagement with the slider 102011, and the second stepping motor 10201 drives the second screw rod 102010 to move the moving block or base on the slide rail 10209.

As shown in FIGS. 10-13, the first electromagnet 10101 and the second electromagnet 10112 positions the metal plate of the box-type part. The structure of the first electromagnet 10101 mainly includes, such as a first resin 1010101, a first enameled wire 1010102, a first framework 10103, and a first shell 1010104. The second electromagnet 10112 mainly includes, such as a second housing 101201, a fourth frame 101202, a fourth enameled wire 101203, and a fourth resin 101204.

The first electromagnet 10101 is a three-sided adsorption electromagnet to realize the adsorption of three sheet metals and is positioned on the second base 10126 through the second diamond pin 10123 and the third cylindrical pin 10125. The first electromagnet 10101 is connected with the second base 10126 through threads. The second electromagnet 10112 realizes the adsorption of two sheet metals, the second electromagnet 10112 and the electromagnet fixing plate 10115 are connected through threads, and the electromagnet fixing plate 10115 is positioned on the first fixing block 10116 through the fourth cylindrical pin 10130 and the first diamond pin 10114. The first fixing block 10116 is provided with a through-hole, and the electromagnet fixing screw 10113 is connected with the electromagnet fixing plate 10115, the first fixing block 10116, and the second electromagnet base 10120. When the electromagnet is energized, current is generated in the coil, and the electromagnet generates magnetic force to act on the sheet metal. In order to avoid the mutual influence of different magnetic force surfaces in the process of adsorbing the sheet metal by the electromagnet, The first shell 1010104, and the second shell 101201 are made of low carbon steel shell surface sprayed with Ni—Cu—Ni coating, and the third frame 1010111, the second frame 1010106, the first frame 1010103, the fifth frame 101206 and the fourth frame 101202 are made of polyethylene plastic.

Calculating a magnetic attraction force according to the basic calculation formula of DC electromagnet attraction force, as follows:

$${F}_{x} = {( \frac{Φ}{5000} )}^{2} \times ( \frac{1}{S} )$$

When the electromagnet absorbs sheet metal, the working air gap is small; wherein, the magnetic flux is

$$Φ = \frac{IW}{2 {R}_{δ}} ,$$

the reluctance is

$${R}_{δ} = \frac{δ}{μ {S}_{δ}} ,$$

l is coil current, W is coil turns, δ is magnetic flux length, μ is permeability; S is the area of magnetic pole.

Simplifying the above formula, then the electromagnetic attraction force is:

$${F}_{attraction} = 1.57 {( IW )}^{2} {S}_{δ} {δ}^{2} \times {10}^{- 8}$$

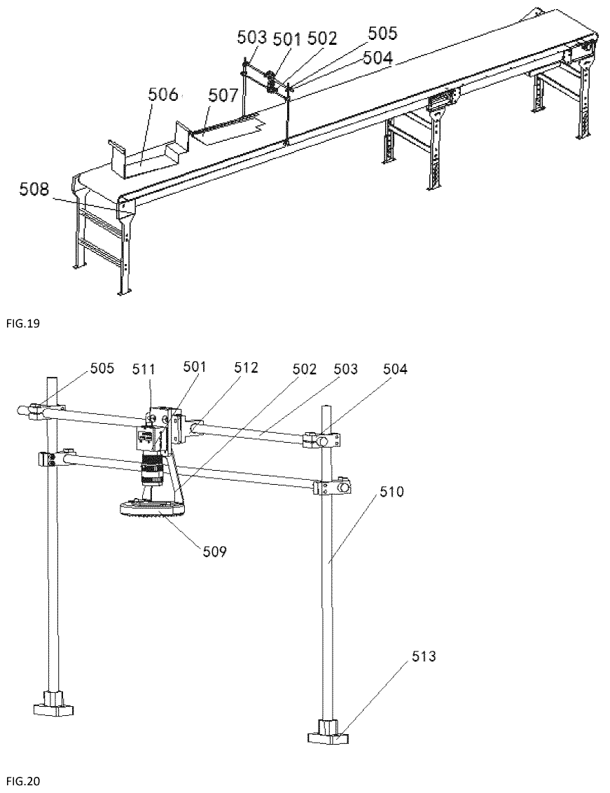

As shown in FIG. 19, the first conveyor belt 508 transports the fourth sheet metal 506 and/or the fifth sheet metal 507 to the gripping position of the sucker robot 4, and the fourth sheet metal 506 and/or the fifth sheet metal 507 passes through the vision recognition device 5 on the first conveyor belt.

As shown in FIG. 20, the first CCD camera 501 recognizes, through a convolutional neural network algorithm, two shapes of the fourth sheet metal 506 and/or the fifth sheet metal 507, wherein the convolutional neural network algorithm includes: an input terminal, a convolution lay, a pooling lay, an activation function and loss function of full connection layer, wherein, establishing a data set through a large number of images of sheet metal shapes shot by the first CCD camera, and the photographed images are input into the convolution neural network for testing during sheet metal recognition to further recognize sheet metal shapes. The first CCD camera 501 is fixed on the first CCD camera bracket 511, the second annular light source 509 illuminates the sheet metal to highlight the sheet metal characteristics of the fourth sheet metal 506, and the fifth sheet metal 507, the cross-bar 503 is clamped by the clamping block 504, and the other end of the clamping block 504 clamps the vertical bar 510. The vertical rod 510 is provided with a vertical rod base 513 for connecting with the first conveyor belt.

As shown in FIGS. 14 and 15, the two suction cups 40202 are connected with the air pipe 40201, to realize the suction of the sheet metal through vacuum suction; the fourth nut 40205 connects the aluminum profile frame 40203 through the first sheet metal 40204; one end of the aluminum profile frame 40203 is connected with the sixth frame 40207 and the second sheet metal 40206 through threads; and the butterfly nut 402012 fixes the sixth frame 40207 on the robot arm joint through the third sheet metal 402013. In order to ensure that the sucker robot 4 can accurately grasp the sheet metal, the trajectory planning of the sucker robot 4 needs to be carried out. The trajectory planning of the sucker robot 4 is similar to that of the welding robot. A D-H model is used to establish the motion model of the sucker robot and analyze the kinematics of the sucker robot.

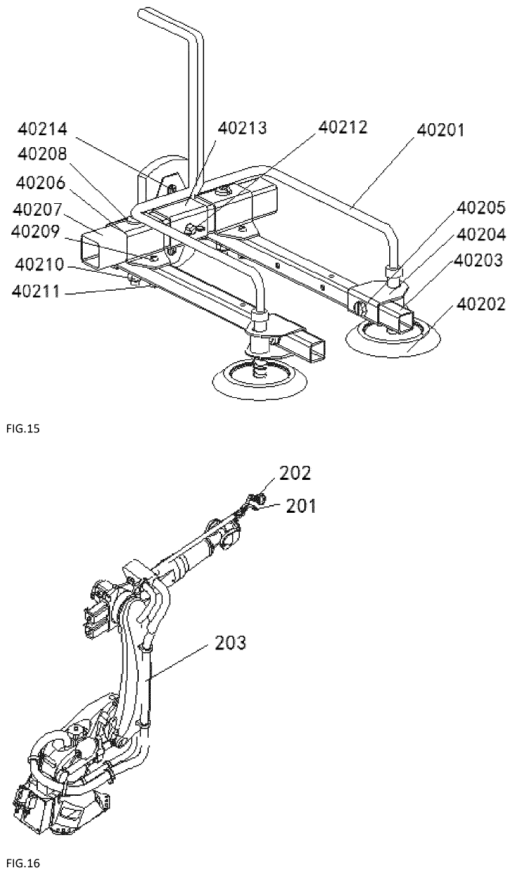

As shown in FIG. 16, the welding robot 2 includes, such as a welding gun 201, a vision recognition device 202, a first robot arm 203, etc. After the welding fixture 1 positions and holds the sheet metals of the box-type part, the vision recognition device 202 recognizes the welding seam and transmits a signal to the control system, and the control system controls the welding gun 201 to weld the welding seam.

The vision recognition device 202 generally includes a CCD camera or a CMOS camera. The CMOS camera has lower chip power consumption but higher noise than the CCD camera; in addition, the image quality captured by the CCD camera is higher than that of the CMOS camera, so the CCD camera is used in the present example. As shown in Table 1, the technical parameters of the CCD camera and CMOS camera are compared.

TABLE 1
Comparison of technical parameters
between CCD camera and CMOS camera

| performance parameters | CCD camera | CMOS camera |
|---|---|---|
| sensitivity | high | medium |
| dynamic range | high | medium |
| consistency | high | medium to high |
| anti-smear performance | high | high |
| noise ratio | low | high |
| operating voltage | higher | lower |
| power consumption | high | low |
| fill factor | high | medium |
| output pixel signal | point set | voltage |

Specifically, the vision recognition device 202 includes, such as, a first annular light source 20201, a lens 20202, a second CCD camera 20203, a fourth fixed block 20201. The recognition of the welding seam is mainly performed by pre-processing the photographed images by the second CCD camera 20203. In order to overcome the influence of environmental light sources and ensure the stability of images, the first annular light source 20201 is used.

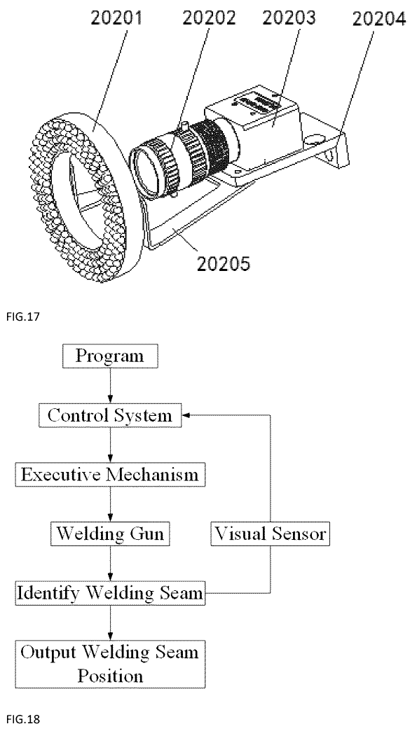

As shown in FIG. 18, the welding seam recognition system mainly includes three parts: a control system, an executive mechanism, and a vision sensor; the welding gun and the vision sensor are arranged at the end of the robot arm of the welding robot, the vision sensor shall be at a front end of a welding direction of the welding gun, to obtain welding seam image and transmit it to the control system, a software in the control system preprocesses the welding seam image to obtain the feature points of the welding seam, to obtain the accurate position of the welding seam.

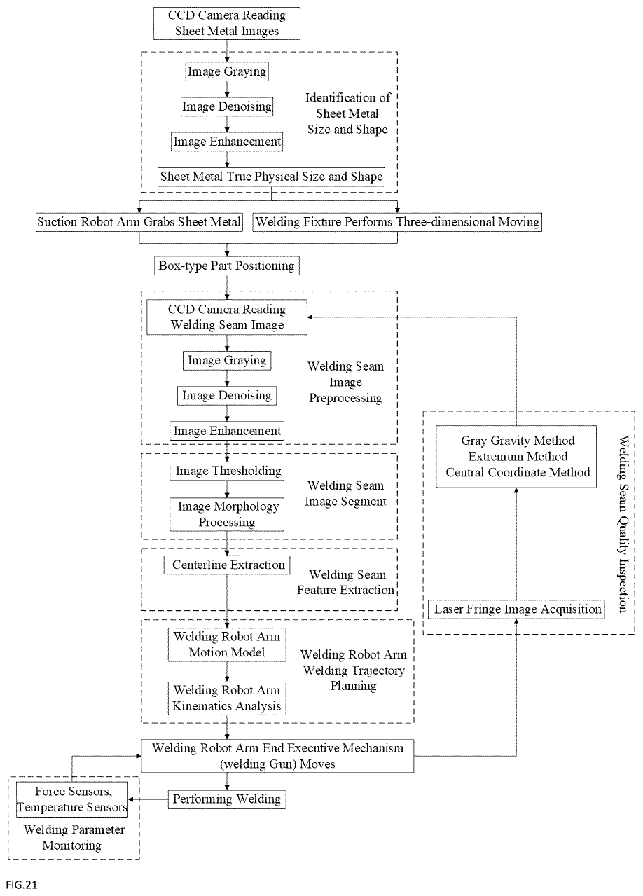

As shown in FIG. 21, the CCD camera captures images, analyzes the size of the sheet metal after capturing, and transmits signals to the executive mechanism of the welding fixture to drive the welding fixture to perform an X/Y/Z three-direction movement. The sucker robot grasps the recognized sheet metal, and the electromagnets adsorb the sheet metal. The CCD camera at the front end of the robot arm of the welding robot recognizes the welding seam. The welding seam recognition system on the welding robot includes welding seam image acquisition, welding seam image pre-processing, welding seam image segmentation, and welding seam feature extraction. The welding seam image preprocessing flow mainly includes welding seam image denoising, welding seam image thresholding, and welding seam edge detection. A working principle thereof is as follows:

The industrial camera (CCD camera) captures the shape of the surface of the welding parts and the welding seam image, the image processing controller performs processing and calculation on the captured welding seam image, extracts feature points of the welding seam, calculates the welding seam position according to the information of the feature points, and then calculates the direction and displacement of the welding gun to be moved in space according to the calculated position.

Performing a gray-scale processing on the captured welding seam color images by the CCD camera, to reduce unnecessary data calculation and shorten the recognition time of welding seam image. The color image can be expressed by the following formula, which is:

F(x,y)=[f_{R}(x,y),f_{G}(x,y),f_{B}(x,y)];

Wherein, (x, y) is pixel coordinate, F(x, y) is luminance information of image at (x, y); f_{R}(x, y) is luminance information of image at R point; f_{G}(x, y) is luminance information of image at G point; f_{B}(x, y) is luminance information of image at B point.

The image denoising includes mean filtering, Gaussian filtering, and median filtering. Performing the gray stretching on the processed welding seam image, wherein the linear transformation function of the image is often used to realize the gray stretching of the image. The function expression is as follows:

$$s = \frac{d - c}{b - a} ( r - a ) + c$$

Wherein, s is the stretching function; a is the minimum gray value of the original image, b is the maximum gray value of the original image; c is the minimum gray value after transformation, d is the maximum gray value after transformation; r is the gray value of the current pixel point.

Performing the segmentation on the processed welding seam image, wherein the image thresholding processing is widely used in the image segmentation, and generally, it is assumed that the image after thresholding is g(x, y), and the calculation formula is:

$$g ( x , y ) = \{ \begin{matrix}1 , & f ( x , y ) > T \\ 0 , & f ( x , y ) \leq T\end{matrix} \}$$

Wherein, f(x, y) is the image; T is the threshold.

After the thresholding processing, there may be holes in the image, so it is necessary to eliminate the holes by the image morphology operation.

Finding the centerline of the weld, including screening the points whose gray value is greater than 0 in each row, the screened points are the points in the welding seam area, and using these points as the points for calculating the gray center of gravity of the row. Then calculating the barycentric coordinates of the welding seam row by row as central coordinates thereof. Assuming that the coordinates of the k^{th} row are set to (xₖ, yₖ), then the coordinates of the welding seam center of the k^{th} row can be expressed as:

$$\{ \begin{matrix}{X}_{K} = \frac{{\sum }_{i = 1}^{M} f ( {x}_{i} , {y}_{k} ) {x}_{i}}{{\sum }_{i = 1}^{M} f ( {x}_{i} , {y}_{k} )} \\ {y}_{k} = k\end{matrix} \}$$

Wherein, M is the width of the welding seam zone; i is a variable; k is the number of rows in the welding seam zone; and F(xᵢ, yₖ) is the coordinate of the k^{th} row.

In order to ensure that the welding robot can accurately and stably move and weld in the welding process, it is necessary to plan the robot arm trajectory. The robot arm trajectory is solved mainly through kinematics, forward kinematics solution, inverse kinematics solution, and robot space analysis.

In the present example, using a KUKA robot and establishing a robot motion model. The main principle of the motion model is to, firstly, establish a link coordinate system at the rotating shaft of the robot arm, then describe the translation and rotation relationship between two adjacent links in matrix form, and finally solve the position and attitude of the robot arm by a secondary transformation matrix. When establishing the linkage coordinate system, the base of the KUKA robot is set as the first linkage, and the end executive mechanism of the robot arm is set as the end linkage. A base coordinate system is established on the base of the robot and is regarded as an absolute coordinate system.

Under the condition that the joint angle value and the link parameter of the robot arm are known, the forward kinematics analysis of the robot arm is carried out, and the transformation matrix of the coordinate system of the executive mechanism at the end of the robot arm relative to the base coordinate system of the robot arm is obtained:

$${}_{6}^{0} T = {}_{1}^{0} T {}_{2}^{1} T {}_{3}^{2} T {}_{4}^{3} T {}_{5}^{4} T {}_{6}^{5} T = [ \begin{matrix}{n}_{x} & {o}_{z} & {a}_{x} & {p}_{x} \\ {n}_{y} & {o}_{y} & {a}_{y} & {p}_{y} \\ {n}_{z} & {o}_{z} & {a}_{z} & {p}_{z} \\ 0 & 0 & 0 & 1\end{matrix} ] = [ \begin{matrix}{R}_{ij} & \overline{{p}_{ij}} \\ 0 & 1\end{matrix} ]$$

Wherein, T is the link transformation; nₓ, n_{y}, n_{z} are the terminal point attitude; a is the robot link length; pₓ, p_{y}, p_{z} are the terminal point position; x, y, z are the three-dimensional spatial coordinates; Rᵢⱼ is the rotation transformation matrix between the terminal coordinate system and the base coordinate system, describing the attitude relationship; p̅ᵢ̅ⱼ̅ is the translation transformation matrix between the terminal coordinate system and the base coordinate system, describing the position relationship.

In order to determine the posture of the welding gun at the end of the robot arm and calculate the rotation angle of each joint of the robot, it is necessary to perform the inverse kinematics on the robot arm, that is, to calculate the joint angle of each joint under the condition that the posture of the welding gun at the end of the robot is known. Pre-multiply (₁⁰T)⁻¹ on both sides of the transformation matrix to obtain the angles of each joint: θ₁=arctan(p_{y}/pₓ), through the formulas as follows:

$${s}_{1} {p}_{y} + {c}_{1} {p}_{x} = {a}_{2} {c}_{2} + {a}_{3} {c}_{23} - {d}_{4} {s}_{23}$$

$${p}_{z} = - {a}_{3} {c}_{23} + {a}_{2} {s}_{2} + {d}_{4} {c}_{23}$$

And then, θ₂, θ₃, θ₄, θ₅, and θ₆ can be solved similarly by the above principle.

Controlling the robot to complete welding accurately and steadily from the master, the core is the trajectory planning of the welding gun at the end of the robot arm. Under the conditions of geometric path constraints, obstacle constraints, motion, and power, the expected motion trajectory of the welding gun end is calculated. The trajectory planning algorithm of a robot is generally divided into two categories: joint space algorithm and Cartesian algorithm. A joint space algorithm is suitable for point-to-point operation scenes such as handling, stacking, etc. The Cartesian algorithm is suitable for welding, cutting, spraying, and other continuous path scenes. In the present invention, a Cartesian space algorithm is adopted.

In case of welding, the welding seam is mostly a straight line, so the linear interpolation algorithm is adopted in the welding path planning, that is, the welding gun performs welding according to the straight line. After determining the starting point and the ending point of the welding seam of the box-type parts, the coordinates of the middle point are calculated, and the robot arm passes through each point to simulate the linear motion track. Set Q₁(X₁, Y₁, Z₁) as the starting point of the trajectory in space, Qₙ(Xₙ, Yₙ, Zₙ) as the middle-end point of the trajectory, and combine the spatial coordinates to obtain the length L of Q₁ to Qₙ. The length L is calculated by the following formula:

$$L = \sqrt{{( {X}_{n} - {X}_{1} )}^{2} + {( {Y}_{n} - {Y}_{1} )}^{2} {( {Z}_{n} - {Z}_{1} )}^{2}}$$

The minimum interpolation step size is m, the total number of interpolation points N=L/m+1, and the intervals between each two interpolation points in X, Y and Z axes can be obtained:

$$Δ X = \frac{{X}_{f} - {X}_{0}}{N}$$

$$Δ Y = \frac{{Y}_{f} - {Y}_{0}}{N}$$

$$Δ Z = \frac{{Z}_{f} - {Z}_{0}}{N}$$

Coordinates of the i^{th} interpolation point:

$${X}_{i + 1} = {X}_{i} + i Δ X$$

$${Y}_{i + 1} = {Y}_{i} + i Δ Y$$

$${Z}_{i + 1} = {Z}_{i} + i Δ Z$$

In order to guarantee stable operation and welding quality and improve welding efficiency, it is necessary to plan the welding speed and acceleration of the welding gun at the end of the robot arm. In the process of velocity planning, the length of the machining path is determined and normalized, the maximum velocity and acceleration of robot welding are constrained, the acceleration section, uniform speed section, and deceleration section of the path are determined when the velocity curve is selected, and the interpolation time is set to calculate the pose of interpolation points on the path regularly. Speed planning algorithms include the trapezoid speed algorithm, S speed algorithm, and sine speed algorithm. In order to avoid a certain impact on the robot arm and ensure smoothness in the welding process, a sine speed algorithm is adopted. Table 2 shows a comparison of three-speed planning algorithms:

TABLE 2
Comparison of three-speed planning algorithms

| | trapezoidal velocity | S-velocity | sinusoidal acceleration |
|---|---|---|---|
| speed | trapezoidal continuity | S-type continuity | sinusoidal continuity |
| acceleration | step discontinuity | trapezoidal continuity | sinusoidal continuity |
| jerk | pulse-type | step discontinuity | sinusoidal continuity |
| achievement difficulty | simple | complex | medium |

Welding quality monitoring includes measurement of weld formation size and identification and classification of weld surface defects. Weld formation size includes shape size (melt width, excess height) and defect size (undercut, plate displacement); weld surface defects include surface pores, cracks, and depressions. In order to improve welding quality, an intelligent recognition algorithm is used to recognize and classify laser fringe images of weld defects, and weld surface quality inspection is realized. In weld quality inspection, the deformation of the laser fringe curve is used to characterize the weld profile and intuitive and comprehensive weld information is fed back in the form of laser fringe images. Then, the CCD camera is used to preprocess and extract characteristics of weld images, and weld quality inspection of box-type parts is realized. In the present example, the force sensor and the temperature sensor are used to sense parameters in the welding process in real-time, the force sensor is installed on the welding gun to sense force information in the welding process in real-time, and the force information is transmitted to the control system to control the welding strength of the robot. The temperature sensor is installed on the welding gun to sense the temperature change in the welding process in real-time, control the welding temperature, and monitor the temperature abnormality in the welding process.

### Example 3

The present example provides a method for welding box-type parts, which adopts the intelligent production line for welding the box-type parts described in Example 2, including:
adjusting, by a two-dimensional moving apparatus the position of each of a plurality of lifting apparatuses, and determining the height of each of the plurality of lifting apparatuses according to sheet metal dimensions of an object to be welded; after the adjustments of the two-dimensional moving apparatus and the plurality of lifting apparatuses, holding and positioning the object to be welded by using a first electromagnet and a second electromagnet on the each of the plurality of lifting apparatuses; and, after the object to be welded are positioned, welding, by a welding robot, the object to be welded in one piece.

In the present example, acquiring, by using a camera on the welding robot, an image of the surface shape of the object to be welded, and an image of the welding seam;
carrying out a gray-scale processing and a noise elimination processing on color images acquired by the camera; carrying out a gray-scale stretching on the processed image of the welding seam; segmenting the stretched image of the welding seam; and, eliminating an interference information of holes on the segmented image of the welding seam through an image morphology operation;
screening points of which a gray value is greater than 0 in each row in the segmented image of the welding seam, then the screened points are of points of an area of the welding seam, and using the points to calculate a gray-scale center of gravity of each the row; and then, calculating, row by row, coordinates of a center of the gravity of the welding seam, as coordinates of a middle point; and
planning, by using a linear interpolation algorithm, a welding path of a robotic arm of the welding robot; performing, by a welding gun on the welding robot, the welding according to the planned straight line, wherein calculating the coordinates of middle points of the welding seam after determining a starting point and an ending point of the welding seam of the object to be welded, and simulating, by the robotic arm of the welding robot passing through each of the middle points, a linear motion track.

The foregoing descriptions are merely preferred embodiments of the present invention but are not intended to limit the present invention. A person skilled in art may make various alterations and variations to the present invention. Any modification, equivalent replacement, or improvement made within the spirit and principle of the present invention shall fall within the protection scope of the present invention.

1. A welding fixture for box-type parts, comprising a two-dimensional moving apparatus and a plurality of lifting apparatuses provided on the two-dimensional moving apparatus;
each of the plurality of lifting apparatuses comprises a first electromagnet being arranged at a first end of the lifting apparatus far away from the two-dimensional moving apparatus, and a second electromagnet being arranged at a second end of the lifting apparatus close to the two-dimensional moving apparatus; wherein, the first electromagnet is provided with three mutually perpendicular magnetic surfaces, and the second electromagnet is provided with two mutually perpendicular magnetic surfaces.

2. The welding fixture for box-type parts according to claim 1, wherein the two-dimensional moving apparatus comprises a first moving apparatus and a second moving apparatus that move perpendicular to each other on a horizontal plane.

3. The welding fixture for box-type parts according to claim 1, wherein the first electromagnet comprises a first shell, internal spaces of the first shell corresponding to the three mutually perpendicular magnetic surfaces of the first electromagnet are respectively provided with a frame, and an enameled wire is wound around the frame; and, the second electromagnet comprises a second shell, internal spaces of the second shell corresponding to the two mutually perpendicular magnetic surfaces of the second electromagnet are respectively provided with a frame, and an enameled wire is wound around the frame.

4. An intelligent production line for welding the box-type parts, comprising a first conveyor belt, a welding fixture arranged on a first end of the first conveyor belt, a welding robot arranged on a first side of the welding fixture, a sucker robot arranged on a first side of the first conveyor belt and close to the welding fixture, and a second conveyor belt; wherein,
the welding fixture includes a two-dimensional moving apparatus, and a plurality of lifting apparatuses arranged on the two-dimensional moving apparatus; wherein,
each of the plurality of lifting apparatuses comprises a first electromagnet being arranged at a first end of the lifting apparatus far away from the two-dimensional moving apparatus, and a second electromagnet being arranged at a second end of the lifting apparatus close to the two-dimensional moving apparatus; wherein, the first electromagnet is provided with three mutually perpendicular magnetic surfaces, and the second electromagnet is provided with two mutually perpendicular magnetic surfaces.

5. The intelligent production line for welding the box-type parts according to claim 4, wherein a first camera is arranged above the first conveyor belt to identify sheet metal dimensions of the box-type parts on the first conveyor belt; wherein, according to the identified sheet metal dimensions, an adjustment position of the each of the plurality of lifting apparatuses by the two-dimensional moving apparatus and an adjustment height of the each of the plurality of lifting apparatuses are determined.

6. The intelligent production line for welding the box-type parts according to claim 4, wherein the sucker robot comprises a first robot arm and suction cups arranged on the first robot arm.

7. The intelligent production line for welding the box-type parts according to claim 4, wherein the welding robot comprises a second robotic arm, and a welding gun, a second camera, and an annular light source arranged on the second robotic arm.

8. A method for welding box-type parts, using the intelligent production line for welding the box-type parts according to claim 4, comprising:
adjusting, by a two-dimensional moving apparatus a position of each of a plurality of lifting apparatuses, and determining a height of the each of the plurality of lifting apparatuses according to sheet metal dimensions of an object to be welded; after the adjustments of the two-dimensional moving apparatus and the plurality of lifting apparatuses, holding and positioning the object to be welded by using a first electromagnet and a second electromagnet on the each of the plurality of lifting apparatuses; and, after the object to be welded are positioned, welding, by a welding robot, the object to be welded in one piece.

9. The method for welding box-type parts according to claim 8, wherein acquiring, by a camera on the welding robot, an image of the surface shape of the object to be welded and an image of the welding seam;
carrying out a gray-scale processing and a noise elimination processing on color images acquired by the camera; carrying out a gray-scale stretching on the processed image of the welding seam;
segmenting the stretched image of the welding seam; and, eliminating an interference information of holes on the segmented image of the welding seam through an image morphology operation; and
screening points of which a gray value is greater than 0 in each row in the segmented image of the welding seam, then the screened points are of points of an area of the welding seam, and using the points to calculate a gray-scale center of gravity of each the row; and then, calculating, row by row, coordinates of a center of the gravity of the welding seam, as coordinates of a middle point.

10. The method for welding box-type parts according to claim 8, wherein planning, by a linear interpolation algorithm, a welding path of a robotic arm of the welding robot; performing, by a welding gun on the welding robot, the welding according to the planned straight line, wherein calculating the coordinates of middle points of the welding seam after determining a starting point and an ending point of the welding seam of the object to be welded, and simulating, by the robotic arm of the welding robot passing through each of the middle points, a linear motion track.

11. A method for welding box-type parts, using the intelligent production line for welding the box-type parts according to claim 5, comprising:
adjusting, by a two-dimensional moving apparatus a position of each of a plurality of lifting apparatuses, and determining a height of the each of the plurality of lifting apparatuses according to sheet metal dimensions of an object to be welded; after the adjustments of the two-dimensional moving apparatus and the plurality of lifting apparatuses, holding and positioning the object to be welded by using a first electromagnet and a second electromagnet on the each of the plurality of lifting apparatuses; and, after the object to be welded are positioned, welding, by a welding robot, the object to be welded in one piece.

12. The method for welding box-type parts according to claim 11, wherein acquiring, by a camera on the welding robot, an image of the surface shape of the object to be welded and an image of the welding seam;
carrying out a gray-scale processing and a noise elimination processing on color images acquired by the camera; carrying out a gray-scale stretching on the processed image of the welding seam;
segmenting the stretched image of the welding seam; and, eliminating an interference information of holes on the segmented image of the welding seam through an image morphology operation; and
screening points of which a gray value is greater than 0 in each row in the segmented image of the welding seam, then the screened points are of points of an area of the welding seam, and using the points to calculate a gray-scale center of gravity of each the row; and then, calculating, row by row, coordinates of a center of the gravity of the welding seam, as coordinates of a middle point.

13. The method for welding box-type parts according to claim 11, wherein planning, by a linear interpolation algorithm, a welding path of a robotic arm of the welding robot; performing, by a welding gun on the welding robot, the welding according to the planned straight line, wherein calculating the coordinates of middle points of the welding seam after determining a starting point and an ending point of the welding seam of the object to be welded, and simulating, by the robotic arm of the welding robot passing through each of the middle points, a linear motion track.

14. A method for welding box-type parts, using the intelligent production line for welding the box-type parts according to claim 6, comprising:
adjusting, by a two-dimensional moving apparatus a position of each of a plurality of lifting apparatuses, and determining a height of the each of the plurality of lifting apparatuses according to sheet metal dimensions of an object to be welded; after the adjustments of the two-dimensional moving apparatus and the plurality of lifting apparatuses, holding and positioning the object to be welded by using a first electromagnet and a second electromagnet on the each of the plurality of lifting apparatuses; and, after the object to be welded are positioned, welding, by a welding robot, the object to be welded in one piece.

15. The method for welding box-type parts according to claim 14, wherein acquiring, by a camera on the welding robot, an image of the surface shape of the object to be welded and an image of the welding seam;
carrying out a gray-scale processing and a noise elimination processing on color images acquired by the camera; carrying out a gray-scale stretching on the processed image of the welding seam;
segmenting the stretched image of the welding seam; and, eliminating an interference information of holes on the segmented image of the welding seam through an image morphology operation; and
screening points of which a gray value is greater than 0 in each row in the segmented image of the welding seam, then the screened points are of points of an area of the welding seam, and using the points to calculate a gray-scale center of gravity of each the row; and then, calculating, row by row, coordinates of a center of the gravity of the welding seam, as coordinates of a middle point.

16. The method for welding box-type parts according to claim 14, wherein planning, by a linear interpolation algorithm, a welding path of a robotic arm of the welding robot; performing, by a welding gun on the welding robot, the welding according to the planned straight line, wherein calculating the coordinates of middle points of the welding seam after determining a starting point and an ending point of the welding seam of the object to be welded, and simulating, by the robotic arm of the welding robot passing through each of the middle points, a linear motion track.

17. A method for welding box-type parts, using the intelligent production line for welding the box-type parts according to claim 7, comprising:
adjusting, by a two-dimensional moving apparatus a position of each of a plurality of lifting apparatuses, and determining a height of the each of the plurality of lifting apparatuses according to sheet metal dimensions of an object to be welded; after the adjustments of the two-dimensional moving apparatus and the plurality of lifting apparatuses, holding and positioning the object to be welded by using a first electromagnet and a second electromagnet on the each of the plurality of lifting apparatuses; and, after the object to be welded are positioned, welding, by a welding robot, the object to be welded in one piece.

18. The method for welding box-type parts according to claim 17, wherein acquiring, by a camera on the welding robot, an image of the surface shape of the object to be welded and an image of the welding seam;
carrying out a gray-scale processing and a noise elimination processing on color images acquired by the camera; carrying out a gray-scale stretching on the processed image of the welding seam;
segmenting the stretched image of the welding seam; and, eliminating an interference information of holes on the segmented image of the welding seam through an image morphology operation; and
screening points of which a gray value is greater than 0 in each row in the segmented image of the welding seam, then the screened points are of points of an area of the welding seam, and using the points to calculate a gray-scale center of gravity of each the row; and then, calculating, row by row, coordinates of a center of the gravity of the welding seam, as coordinates of a middle point.

19. The method for welding box-type parts according to claim 17, wherein planning, by a linear interpolation algorithm, a welding path of a robotic arm of the welding robot; performing, by a welding gun on the welding robot, the welding according to the planned straight line, wherein calculating the coordinates of middle points of the welding seam after determining a starting point and an ending point of the welding seam of the object to be welded, and simulating, by the robotic arm of the welding robot passing through each of the middle points, a linear motion track.
